(19) United States
(12) Patent Application Publication
(10) Pub. No.: US 2025/0138179 A1
(43) Pub. Date: May 1, 2025

(54) UNMANNED AERIAL VEHICLE DETECTION AND LOCALIZATION WITH CELLULAR NETWORK INFRASTRUCTURE AUGMENTED BY RECONFIGURABLE INTELLIGENT SURFACES

(71) Applicant: Technology Innovation Institute-Sole Proprietorship LLC, Masdar City, Abu Dhabi (AE)

(72) Inventors: Aymen Fakhreddine, Abu Dhabi (AE); Jiguang He, Abu Dhabi (AE); Georgios Alexandropoulos, Abu Dhabi (AE)

(73) Assignee: Technology Innovation Institute-Sole Proprietorship LLC, Masdar City, Abu Dhabi (AE)

(21) Appl. No.: 18/692,200

(22) PCT Filed: Dec. 13, 2023
(86) PCT No.: PCT/IB2023/062641

§ 371 Date: Mar. 14, 2024

(30) Foreign Application Priority Data
Nov. 20, 2022 (AE) P6002432/2022

(51) Int. Cl. G01S 13/87; G01S 13/42; H04B 7/04; H04W 16/28

(52) U.S. Cl. CPC G01S 13/878; G01S 13/42; H04B 7/04013; H04W 16/28

(57) ABSTRACT

Systems, methods, and computer-readable media for detecting and localizing a position of an unmanned aerial vehicle (UAV) in an environment. Particularly, a management computer can orchestrate the detection and localization of the UAV using base stations that are part of a cellular network infrastructure, reconfigurable intelligent surfaces (RIS) disposed about the environment, and one or more reference nodes. One or more base stations can transmit detection and localization signals towards one or more RIS instances to direct signals upwards towards UAVs disposed at or above the base stations using various configurations of the RIS instances. Angles of departure or arrival of the localization signal can be used to determine a position of the UAV. After localizing the UAV, a notification message specifying the derived position of the UAV in the environment can be generated.

### CROSS-REFERENCE TO RELATED APPLICATIONS

This application claims priority to United Arab Emirates Patent Application No. P6002432/2022 which was filed on Nov. 20, 2022, the entire contents of which is incorporated by reference herein.

### TECHNICAL FIELD

This disclosure relates to systems, methods, and computer-readable media for detecting and localizing one or more aerial vehicles within an environment using a cellular network infrastructure and reconfigurable intelligent surfaces.

### BACKGROUND

Unmanned aerial vehicles (UAVs) are remotely controlled aerial vehicles that are rapidly increasing in popularity. A UAV can move about an environment and be controlled either by an operator via a remote control or remotely controlled using a wireless communication network. However, in many cases, a UAV can either lose connection to the remote control/wireless communication network. Further, in some cases, the UAV may enter a region designated as not allowing UAV operation for any of a variety of reasons. For example, the UAV may not be allowed to enter an airspace for an airport so as to not inadvertently interfere with airplane traffic departing/landing at the airport.

In such instances, it may be desirable to detect and locate the UAV in the environment. Detecting a position of a UAV can allow for reconnecting the UAV to a remote control or determining if the UAV is within a designated area that prevents UAV access.

A cellular wireless communication network infrastructure is generally densely deployed in various environments, and can be advantageous for localizing and communicating with a UAV. In wireless communication networks, a base station can electrically communicate wireless data between multiple user devices (e.g., cell phones).

The antennas of a base station are generally directed downward to increase network performance in communicating data with ground user devices. The properties of such base stations may make interacting with a UAV difficult if the UAV is operating at a height equal to or above a height of the base station, where the latter is generally not optimized to provide coverage.

### SUMMARY

The present embodiments relate to systems, methods, and computer-readable media for detecting and localizing a position of one or more unmanned aerial vehicles (UAVs) in an environment. Particularly, a management computer can orchestrate the detection and localization of the UAV using base stations that are part of a cellular network infrastructure, reconfigurable intelligent surfaces (RIS) disposed about the environment, and one or more reference nodes. Detecting and localizing a UAV in the environment can allow for establishing a wireless communication between the node and the rest of the wireless network infrastructure.

As part of detecting the presence of a UAV in an environment, the management computer can cause one or more base stations to transmit detection signal(s) toward one or more RIS instances. The RIS instances can reflect the detection signal(s) upwards to deflect a signal off a UAV in the environment. The deflected signal can be received at a base station or a reference node, and the management computer can determine that a UAV is present in the environment using the received signal. Each RIS instance can be in a first configuration to split a detection signal into multiple simultaneous beams targeting different parts of the environment to detect the UAV in the environment.

After detecting the UAV, the management computer can cause the one or more base stations to transmit localization signals towards the RIS instances. The management computer can detect a reception of any of the localization signals at any of the base station and/or the reference node and determine the position of the UAV in the environment using data relating to any of the localization signals received at any of the base station and/or the reference node. For instance, the management computer can derive angles of departure from which the localization signals were transmitted from the RIS and angles of arrival from which the localization signals were received after being deflected off of a UAV.

After localizing the position of the UAV, a notification message specifying the derived position of the UAV in the environment can be generated. The position of the UAV can be used for various actions, such as to establish a wireless connection to the UAV or determine whether the UAV is within a restricted access area (e.g., an airport).

This Summary is provided to summarize some example embodiments, so as to provide a basic understanding of some aspects of the subject matter described in this document. Accordingly, it will be appreciated that the features described in this Summary are merely examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The above and other aspects of the disclosure, its nature, and various features will become more apparent upon consideration of the following detailed description, taken in conjunction with the accompanying drawings, in which like reference characters may refer to like parts throughout, and in which:

FIG. 1 illustrates an example environment for detecting and localizing a UAV according to an embodiment.

FIG. 2 is an example RIS in a first configuration according to an embodiment.

FIG. 3 is an example RIS in a second configuration according to an embodiment.

FIG. 4 illustrates a top view of an environment including a number of simultaneous beam instances of detection signals for detecting a UAV according to an embodiment.

FIG. 5 illustrates an example system to detect a UAV in an environment with a semi-active RIS and a reference node according to an embodiment.

FIG. 6 illustrates an example system for detecting a UAV using a hybrid RIS with receiving capabilities according to an embodiment.

FIG. 7 illustrates an example system for detecting a UAV using a simultaneously transmitting and reflecting RIS for optimal coexistence with ground users according to an embodiment.

FIG. 8 is an example system for localizing a UAV in an environment using AoD information according to an embodiment.

FIG. 9 is an example system for localizing a UAV in an environment using AoA information according to an embodiment.

FIG. 10 provides an example method for detecting and localizing a position of a UAV in an environment according to an embodiment.

FIG. 11 illustrates an example system for detecting and localizing a UAV in an environment according to an embodiment.

FIG. 12 is a block diagram of a special-purpose computer system according to an embodiment.

### DETAILED DESCRIPTION

Any number of unmanned aerial vehicles (UAVs) can maneuver across an environment. For instance, a UAV or other aerial vehicle can transport goods to a destination or capture audio/video content at a specific location. UAVs are generally controlled wirelessly by an operator, through a wireless communication network or directly from a remote control operated by the operator.

As the prevalence of UAVs increase, there is an increase in UAVs operating in a region that does not allow UAV operation, or UAV that generally are non-cooperative to rules established for a region. Many radar systems are capable of detecting large aircraft and drones flying at high altitudes but may be unable or less efficient in identifying smaller UAVs flying at lower altitudes.

A cellular communication network infrastructure may be used to locate a UAV in an environment. Generally, the cellular network may include one or more base stations in an environment that can be configured to use signaling to both detect and localize a location of the UAV. For example, a signal can be transmitted from the base station and reflected back from the UAV to the base station, embedding the location information of the UAV. Further, if the signal is received at other base stations, the location of the UAV can be triangulated based on the angles of arrival at all the base stations.

However, base stations for a cellular network generally include antennas directed downwards to receive and transmit wireless data with user devices (e.g., cell phones) at a ground elevation. The orientation of the base station can result in difficulty in using signaling to detect and locate a UAV that is at a height at or above the height of the base stations.

Further, in many cases, drone detection, recognition, localization, and tracking solutions can include computer vision (CV), acoustic arrays, and/or radio frequency (RF) fingerprinting. For instance, by equipping high-definition cameras on the roof of the buildings, a system can detect the absence/presence of a flying object in the sky. However, such CV-based drone detection systems may have poor performance in adverse weather and air conditions, such as, fog, dust, and rain. Further, such systems may be unable to distinguish objects with a shape similar to that as a UAV (e.g., a bird). The acoustic arrays may suffer from background noise, and the detection range may be relatively limited due to the severe propagation path loss, usually less than 1000 meters. The radio frequency (RF) fingerprinting may only be operable when the RF signals are emitted from either the drones for data streaming or the remote controller for control signaling. Data fusion can be exploited by fusing data from different sensors readings, but it can inherently increase the resources needed for deployment and maintenance, and the computational complexity.

The present embodiments relate to systems and methods for drone detection and 3D localization utilizing a cellular network infrastructure. Particularly, a UAV in an environment can be detected and localized using signaling from base stations and directed by Reconfigurable Intelligent Surfaces (RISs) (or simply “configurable reflective surfaces”) disposed about an environment. The system can enable detection and 3D localization of UAVs and other aerial vehicles flying in the environment.

The system can utilize the infrastructure of cellular networks augmented with Reconfigurable Intelligent Surfaces (RISs). The RISs can be capable to offer tunable reflections to direct signals upwards. Further, the system can include reference nodes that are deployed to receive the radio signals reflected by the drones. The placement of the RISs around each cellular Base Station (BS) can be optimized to reflect cellular signal reflections to the sky, targeting at maximizing the illumination area, while avoiding harming conventional uplink and downlink communications of other devices.

In some instances, there may not be any communication between the drone and the network infrastructure, as the present embodiments can utilize signal reflection to detect and localize the UAVs. The reference nodes can include receiving antenna arrays placed around the area of interest to protect in a way that the presence of one or more non-cooperating drones, flying nearby these nodes, makes the received power profile on the considered frequency change abruptly. The use of several RISs and reference nodes in a networked fashion can enable the localization of the trespasser drone using either or both Angle-of-Departure (AoD) information from the RISs or/and Angle-of-Arrival (AoA) information at the reference nodes. In practice, the detection of the presence/absence of the drone can be done via a generalized likelihood ratio test (GLRT). For the AoD/AoA-based user localization and tracking, BS beamforming and RIS phase profiles can be jointly designed based on their previous states and the previous estimates with the aid of super-resolution tracking approaches.

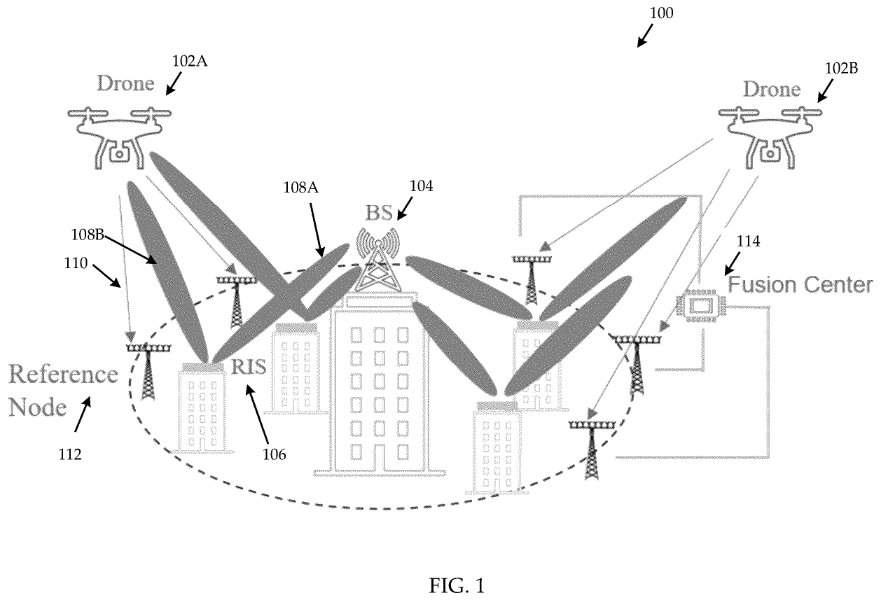

FIG. 1 illustrates an example environment 100 for detecting and localizing a UAV. As shown in FIG. 1, the environment 100 can include UAVs 102A-B operating in the environment above a base station (BS) 104 and other reference nodes (e.g., 112). Further, the BS 104 and the UAVs 102A-B can wirelessly communicate via RIS instances (e.g., 106) disposed in the environment. For example, in FIG. 1, BS 104 can transmit a signal 108A toward an RIS 106. The RIS 106, in turn, can re-direct the signal 108B to the UAV 102A. Similarly, signals deflected from the UAV 102A can be obtained by a reference node 112 or the BS 106 via RIS 106. The RIS 106 can be re-configurable to improve performance in detecting and localizing the UAV 102A located above the BS 104.

In some instances, the re-direction of the signals by the RIS 106 can allow for a BS 104 to wirelessly transmit signals above the BS 104 with increased signaling performance.

Further, a fusion center (or “management computer”) 114 can be in electrical communication with any of the BS 104, RIS 106, reference nodes (e.g., 112), etc. The fusion center 114 can orchestrate wireless communication between the BS 104 and UAVs 102A-B via the RIS 106. Further, the fusion center 114 can facilitate the detection and localization of any UAV as described herein. For instance, if UAV 102A is no longer identifiable or loses a connection, the fusion center 114 can instruct the BS 104 to transmit detection and localization signals while also instructing the RIS 106 to be configured in various configurations to detect and localize the UAV 102A.

### RIS Configuration

As described above, a RIS (e.g., 106) can be re-configurable into various configurations. For example, elements of the RIS can be positioned to re-redirect signals as described herein. For instance, for detection of a UAV, the RIS can be configured in a first configuration where the elements cause a sub-array beam pattern to split a signal into multiple simultaneous beams with a lower resolution. Further, for localization of a detected UAV, the RIS can be configured in a second configuration where the elements cause a signal to be re-directed to a different angle at each time slot to localize the UAV. The management computer can instruct a controller for each RIS to modify its configuration as described herein.

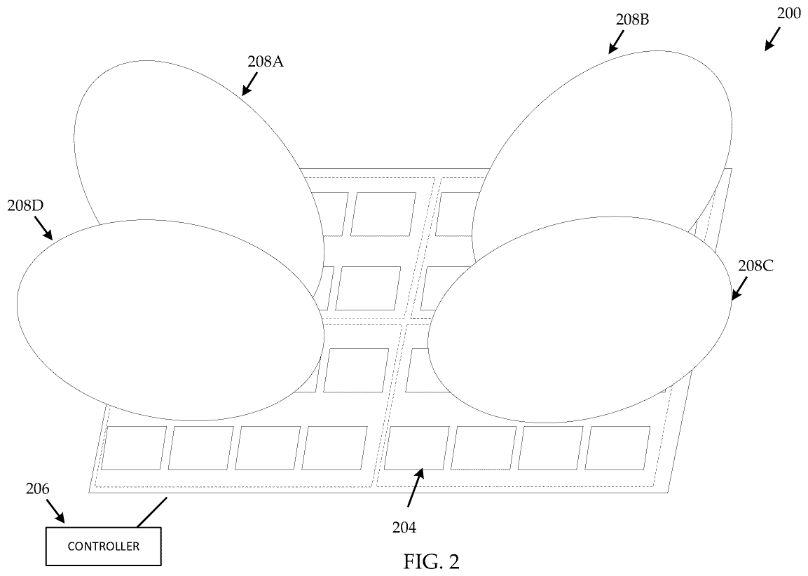

FIG. 2 is an example RIS 200 in a first configuration. As shown in FIG. 2, the RIS 200 can include a series of elements (e.g., 204). Each element can be part of the RIS and can be modified based on a configuration of the RIS 200. For example, the elements can form a first configuration comprising a sub-array beam pattern. The first configuration can receive a signal (e.g., a detection signal) and split the signal into multiple simultaneous beams. The first configuration can enact a wide beam coverage, but with lower beamforming gains and a lower resolution. For example, the detection beam can be split into four simultaneous beams 208A-D in response to being reflected by the RIS 200 in the first configuration. The first configuration can be used to direct a detection signal into a wider coverage area to detect the presence of a UAV.

A controller 206 in electrical communication with the RIS 200 can implement the configuration settings for the RIS 200. For instance, the instruction to configure the RIS sent by the management computer can be sent to the controller 206 which, in turn, can implement the instruction provided by the management computer.

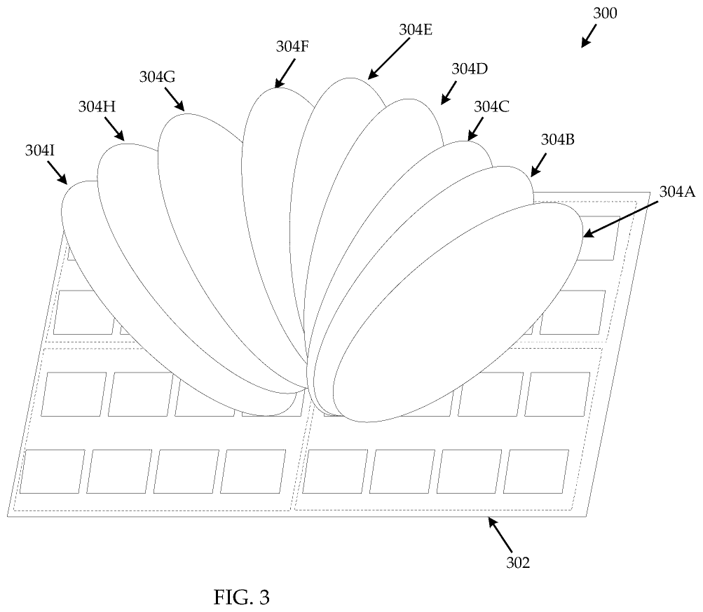

The RIS can both upgrade current cellular networks by providing a 3D radio coverage in altitudes above those of the BS antennas that are generally tilted/directed downwards and be able to beam-focus a high power to a specific direction or point; or beam simultaneously towards different directions/points are functionalities of particular interest for detection and localization purposes. For example, FIG. 2 illustrates a RIS configuration with multiple simultaneous beams that provides a subarray-based beam pattern and provides wide coverage, but less beamforming gains and low resolution. Further, in FIG. 3, the RIS configuration can provide a beam sweeping design that provides less coverage per each beam, but high beamforming gains with high resolution as it focuses a single beam per time slot.

The goal for the first configuration (e.g., the configuration as described in FIG. 2) can be to make the illuminated portion of the sky as large as possible. This portion, especially its (x,y) component, can depend on the beam design and the number of deployed RISs. To provide a larger portion in the z-dimension, reflection amplification can be used at the RIS to improve performance of the signals being reflected at the RIS.

The first configuration can be used to maximize the 3D coverage over the area for coarse detection of a UAV, and then transition to a second configuration that is more fine-grained with higher detection capabilities and that enables 3D localization by providing AoD and AoA information at the level of the RISs and reference nodes. The fusion center can connect the reference nodes via the cellular infrastructure and coordinate the information from these nodes and the RISs for detection and localization purposes.

FIG. 3 is an example RIS 300 in a second configuration. As noted above, the second configuration can be used to localize a UAV in the environment. The elements (e.g., 302) of the RIS 300 can be configured to redirect a signal with lower coverage but higher beamforming gains, higher resolution, and a single beam for each time slot. In the second configuration, the elements of the RIS can allow for the signal to be directed to a specific direction at each time slot. A time slot can correspond to time slots for cellular network protocols, such as Time Division Multiple Access (TDMA) or Frequency Division Multiple Access (FDMA), for example.

As shown in FIG. 3, at a first time slot, the RIS 300 can cause the signal to be redirected in a first direction (e.g., 304A). Further, at a second time slot, the RIS 300 slightly modify the angle to cause the signal to be redirected in a second direction (e.g., 304B). The RIS can cause the signal to be directed in various directions, as is shown by signals 304A-I, for example.

### RIS-Based Detection

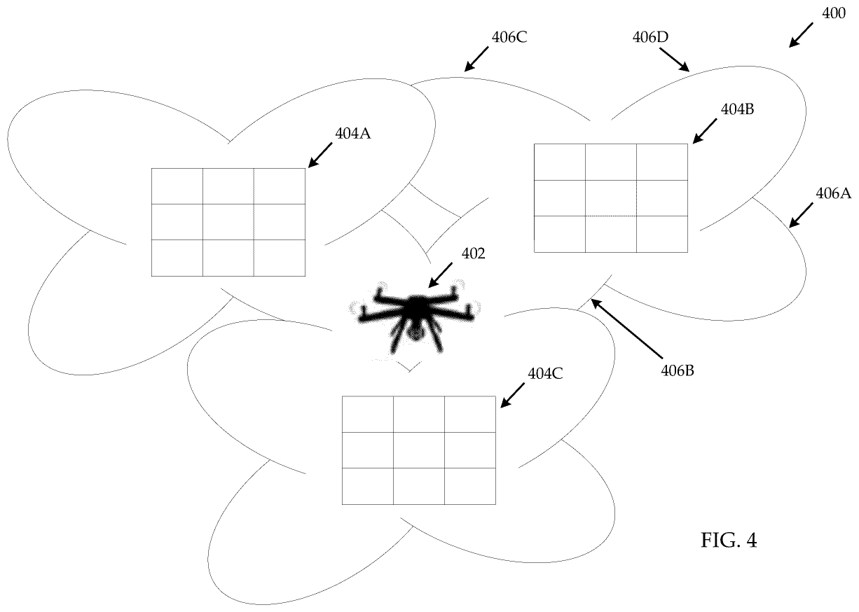

As noted above, one or more base stations can transmit detection signals that are re-directed by corresponding RIS instances to detect the presence of a UAV or other aerial vehicle in an environment. FIG. 4 illustrates a top view of an environment 400 including a number of simultaneous beam instances of detection signals for detecting a UAV 402. In FIG. 4, a base station (not shown) can transmit a detection signal to each corresponding RIS instance (e.g., 404A-C). For instance, a first detection signal can be transmitted to RIS 404B, where the detection signal is split into multiple simultaneous beams (e.g., beams 406A-D).

Each beam (e.g., 406A-D) can be reflected by the RIS 404B in various directions to detect a UAV 402. For instance, a beam 406B can be directed at the UAV 402 and get reflected by UAV 402 back towards the RIS 404B and re-directed to a corresponding base station. Based on the receipt of a detection signal instance at the base station, the management computer can determine a detection of the UAV 402 and further localization can be performed to determine a position of the UAV in the environment.

RIS instances with amplifying properties can improve the 3D coverage for detecting/localizing UAVs. Further, the RIS can partly compensate for the power losses due to pathlosses, multiple reflections, and the relatively small radar-cross sections of the UAVs in the environment.

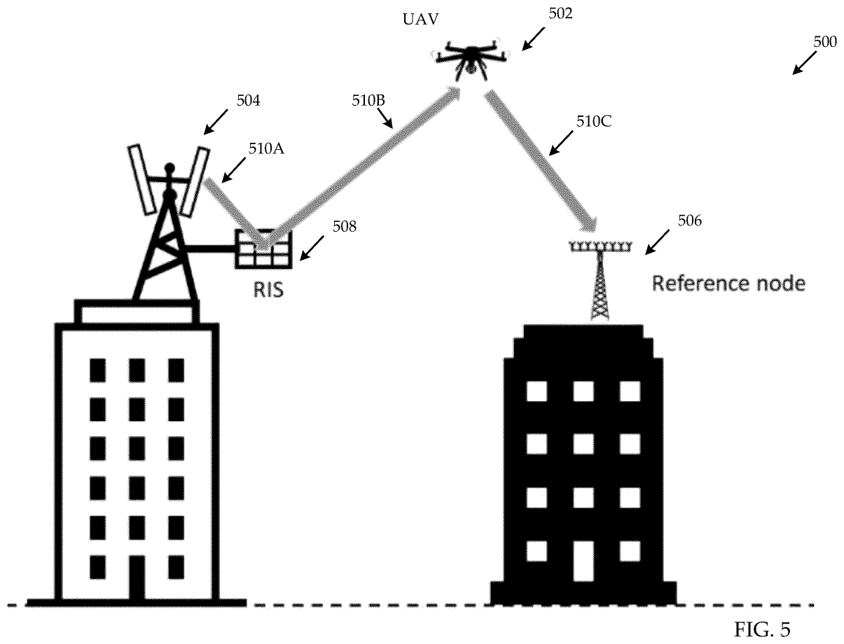

FIG. 5 illustrates an example system 500 to detect a UAV in an environment with a semi-active RIS and a reference node. As shown in FIG. 5, the system 500 can include a UAV 502, a base station 504, RIS 508, and a reference node 506.

In the example in FIG. 5, the base station 504 can transmit a detection signal 510A toward the RIS 508. In response, the RIS 508 in a first configuration can split the detection signal into multiple signal instances (e.g., including re-directed signal 510B) in multiple directions. For instance, signal 510B can be directed toward UAV 502.

The signal 510B can be reflected off of UAV 502, and the reflected signal 510C is captured by the reference node 506. The reference node 506 can receive the signal 510C, and the management computer can determine the detection of the UAV 502 in the environment based on the received signal 510C at the reference node. For instance, the management computer can determine an angle of arrival of the detection signal at the reference node and the position of the reference node to determine that a UAV 502 was detected within an environment (or a defined region within the environment).

In some instances, the reference node(s) can be calibrated by the management computer. The calibration of the reference nodes can be crucial for accurate detection of a UAV based on the received power. Signals directly reaching the reference nodes from the BS or any RIS, as well as other communication signals from or to other cellular user equipment, can cause false alarms.

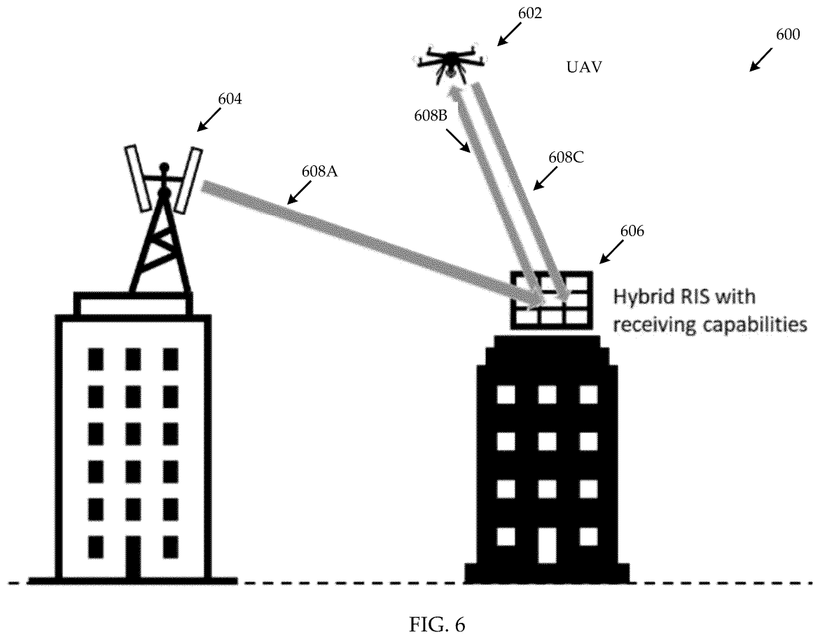

FIG. 6 illustrates an example system 600 for detecting a UAV using a hybrid RIS with receiving capabilities. As shown in FIG. 6, the RIS 606 can direct a detection signal at a UAV 604 and also direct a reflected signal from the UAV back to the base station 604. For example, a detection signal 608A can be transmitted from base station 604 to the RIS 606. The signal (e.g., 608B) can be directed from the RIS 606 towards the UAV 602. The signal (e.g., 608C) can be reflected from the UAV 602 towards the RIS 606 and then re-directed back to the base station 604 or processed at RIS 606 for detection or localization of UAV 602.

In some instances, the RIS can include a semi-passive RIS that reflects incoming signals with or without amplification. Going beyond such designs, a hybrid RIS as described in FIG. 6 can have an added receiving capability. Using the hybrid RIS, a UAV detection design can alleviate the need for reference nodes because of the receiving feature of the hybrid RIS.

The RIS hardware can be designed depending on whether it is intended to be placed on a rooftop or at (or nearby) the BS location itself. A constraint of the RIS can include not causing or increasing degradation of quality of service (QOS) of signals transmitted to user devices by the RIS obstructing the signals. Accordingly, various RIS designs can be utilized to implement a hybrid RIS while also mitigating QoS degradation for the user devices. For example, the RIS can include a large reflective surface placed on a rooftop. The signal may not go through the RIS as all incoming beams are systematically reflected to the sky. Another example design can include smaller surfaces incorporated or attached to the base station and placed at a proximity from down tilted BS antennas. These RISs can have the ability to reflect the signals destined to reach users at higher altitudes, but also refract and not obstruct the other signals making their way to users at lower altitudes. In practice, the RIS reflection and refraction properties can be tuned by separating the two aforementioned classes of signals either in time or frequency by using Time Division Multiple Access (TDMA) or Frequency Division Multiple Access (FDMA), respectively, via RIS structures that are capable of simultaneously reflect and refract in reconfigurable manners. Using any of the example RIS designs can assist to avoid tampering with the other user device connectivity, while extending the deployment possibilities of RIS structures.

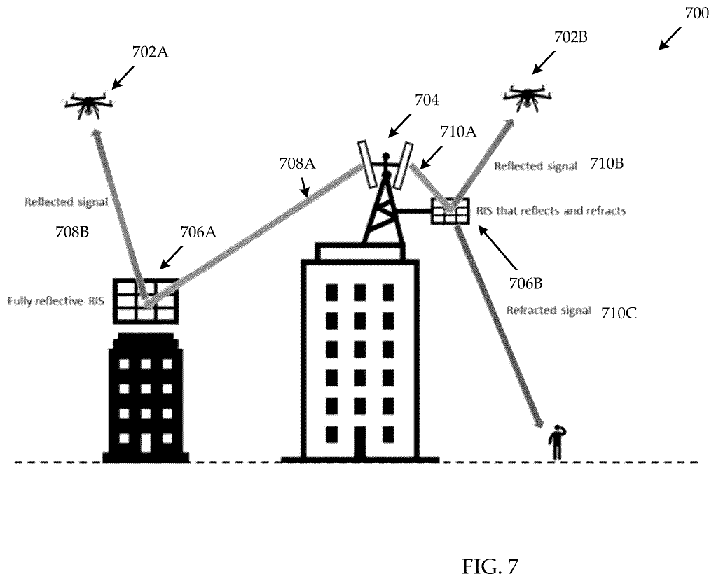

FIG. 7 illustrates an example system 700 for detecting a UAV using a simultaneously transmitting and reflecting RIS for optimal coexistence with ground users. As shown in FIG. 7, the system can include multiple UAVs 702A-B, a base station 704, and RIS instances 706A-B. The BS 704 can transmit separate detection signals 708A, 710A toward RIS instances 706A-B. In response, the RIS instances 706A-B can reflect the signals (e.g., reflected signals 708B, 710B) towards the UAVs 702A-B. Further, in this example, a first RIS instance 706A can include a fully reflective RIS disposed on a rooftop and can re-direct a reflected signal from a UAV 702A to the BS 704. The second RIS instance 706B can include a RIS that can both reflect and refract. The second RIS instance 706B can reflect a detection signal to the UAV 702B and re-direct a reflected signal from the UAV 702B to the BS 704. The second RIS instance 706B can also refract other signals, such as a communication signal 710C between the BS 704 and a user device (or ground user).

During a phrase of sending positioning reference signals for the purpose of UAV/drone detection and 3D localization, the BS may coordinate with the RISs to achieve optimal performance. The BS can send a control signal, either via wireless or wired links, to guide the reflective beam configuration at the RIS(s). One alternative method can include formulating a beam codebook for the RISs. The BS may only need to send the coded beam index to the RIS for indicating which beam to be used in the next time slot. In some instances, an adaptive beam design at the RIS can be implemented.

### UAV Localization

Further, the system design may not only allow for intruder UAV/drone detection, but also include localization features. In some cases, using a Received Signal Strength-based localization technique may be impractical, as it may require a high level of 3D fingerprinting in a large outdoor area. Time-based approaches may not be very useful, as there is no form of communication with the drone to localize. In addition, high-precision estimation of temporal parameters can require a large amount of bandwidth for the pilot signal transmission.

Angle-based localization can be highly appropriated, as it may be possible to extract Angle-of-Arrival information at the level of the reference nodes by using antenna arrays and Angle-of-Departure from the RISs when the RIS is operating in the beam-sweeping mode. A UAV/drone position can be provided by using multi-lateration given AoA and/or AoD inputs and the pre-known coordinates of the reference nodes.

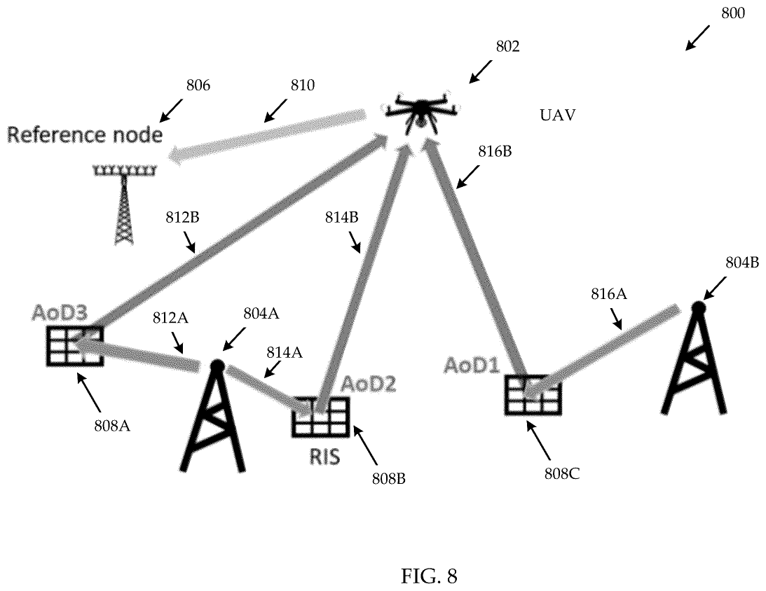

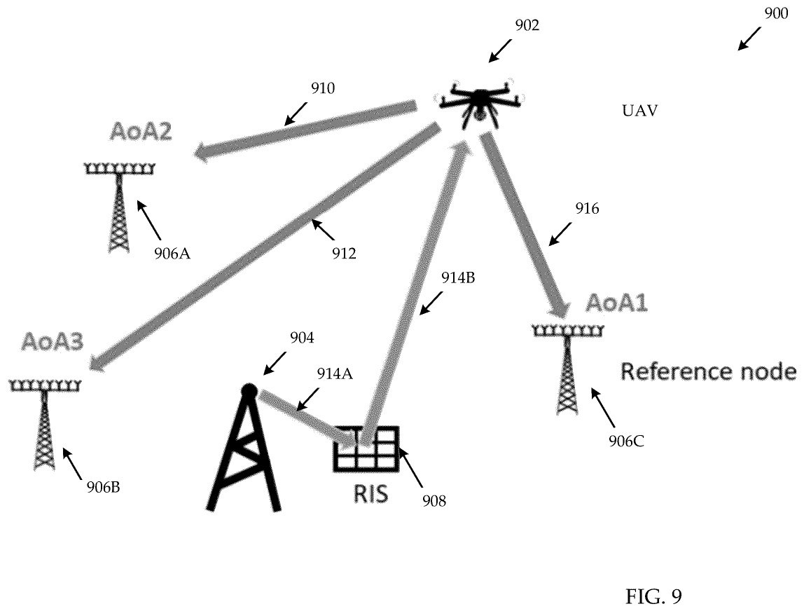

FIGS. 8-9 show localization techniques utilizing AoD and AoA information. Either AoD and/or AoA information can be used either separately or together as inputs to compute a location of the UAV (e.g., in a set of position coordinates). In some instances, if only AoDs and/or AoAs are used as measurements for localization, the system may not require ultra-large bandwidth, narrowband communication in the order of few kHz suffices.

FIG. 8 is an example system 800 for localizing a UAV in an environment using AoD information. As shown in FIG. 8, BS instances 804A-B can transmit localization signals (e.g., 812A, 814A, 816A) toward corresponding RIS instances (e.g., 808A-C). In response, the localization signals can be reflected by each RIS instance to re-direct the signals (e.g., 812B, 814B, 816B) towards a UAV 802. The signals (e.g., 812B, 814B, 816B) can reflect off of the UAV 802 and be re-directed towards various nodes. For example, re-directed signal 812B can be reflected off of the UAV 802 (as shown in signal 810) and received at a reference node 806. Further, signals 814B, 816B can be reflected from UAV 802 and directed back to BS instances 804A-B via RIS instances 808B-C.

A management computer can process each received localization signal at the BS instances 804A-B and reference node 806 to determine a localized position of the UAV 802. For example, an angle of departure (AoD) for each received localization signal can be processed in combination to triangulate a position of the UAV 802 in the environment. The AoD information can include an angle at which each localization signal was reflected off of each RIS instance at the time of transmitting each localization signal.

FIG. 9 is an example system 900 for localizing a UAV in an environment using AoA information. As shown in FIG. 9, the system 900 can include a base station 904 transmitting a localization signal 914A toward a RIS 908. In response, the RIS 908 can reflect the signal (e.g., 914B), which can reflect off of the UAV 902. The signal (e.g., 910, 912, 916) can reflect off of the UAV 902 towards any reference node (906A-C).

The management computer can detect received signals (e.g., 910, 912, 916) at all the reference nodes 906A-C and determine an angles of arrival (AoAs) at all the reference nodes. These AoAs can include data relating to a direction from which each received signal was received at the reference nodes 906A-C. The management computer can map the AoA information to the position of UAV 902 with the aid of pre-known coordinates of all the reference nodes.

### Example Method for Detecting and Localizing a Position of a UAV in an Environment

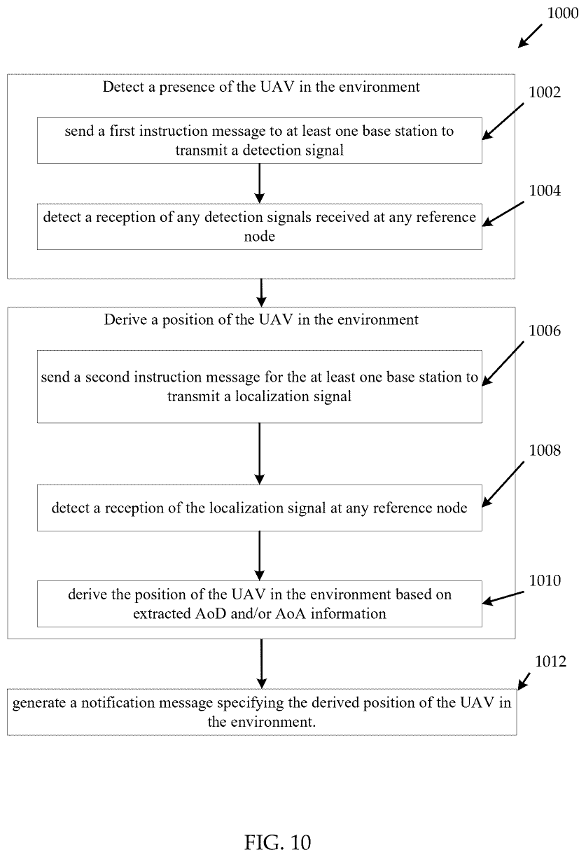

FIG. 10 provides an example method for detecting and localizing a position of a UAV in an environment. The method as described herein can be performed by a management computer or fusion center (e.g., fusion center 114) as described herein.

The method can include detecting a presence of the UAV in the environment. For example, the management computer (e.g., 114 in FIG. 1) can instruct one or more base stations (e.g., base station 104) to transmit pilot signals (e.g., 108A) periodically to detect an UAV in the environment.

In a first example embodiment, the management computer can instruct a first base station to transmit detection signal instances toward multiple (e.g., four) RIS instances. The deflection of the detection signal instances from each RIS instance can allow for broad deflection of signal instances across the environment. In another example embodiment, the management computer can instruct multiple base stations to each send one or more detection signal instances to corresponding RIS instances. The configuration of base stations, RIS instances, and reference nodes in an environment can vary based on the cellular network infrastructure within the environment.

At 1002, detecting the UAV can include sending a first instruction message to one base station to transmit a detection signal. Each detection signal can be re-directed by a corresponding reconfigurable reflective surface (or reconfigurable intelligent surface). For example, as shown in FIG. 1, a detection signal 108A can be transmitted from a BS 104 toward RIS 106. In response, the RIS 106 can re-direct the signal (e.g., reflected signal 108B) upwards towards the UAV 102A.

The reconfigurable reflective surface can be configured in a first configuration to redirect the detection signal into a sub-array pattern. An example of the first configuration is shown in FIG. 2. For example, the management computer can send a third instruction message to a controller for each reconfigurable reflective surface to configure each sub-RIS into a first configuration, where the first configuration can split the detection signal into multiple simultaneous beams in a sub-array pattern.

In some instances, the reconfigurable reflective surfaces can reflect either detection signals and/or localization signals and refract other signals to other user devices. For example, in FIG. 7, the RIS 706B can reflect a detection or localization signal 710B and refract signal 710C intended for a ground user. The RIS 706B can transition between reflective and refractive (or transparent) based on the time slots scheduled for detection and localization signals. In some embodiments the RIS can reflect signals only at specified frequencies (e.g., orthogonal frequencies), while refracting signals of other frequencies.

At 1004, detecting the UAV can also include detecting a reception of any of the detection signals received at the base station and/or a reference node. Any of the received detection signals indicate a detection of the UAV in the environment. For instance, signal 108B can be deflected off of the UAV 102A to determine that the UAV is present in the environment. Further, a deflected signal 110 can be received at reference node 112. The management computer 114 can detect the reception of the deflected signal 110 at the reference node 112 and can determine that the UAV 102A is in the environment.

Responsive to detecting the UAV, a position of the UAV can be localized in the environment. For example, multiple angles (e.g., angle(s) of departure, angle(s) of arrival) derived from localization signals can be aggregated as part of a localization algorithm to derive a position of the UAV. The position of the UAV can be identified by coordinates or another suitable position parameter.

At 1006, localizing the UAV can include sending, to base station, a second instruction message to transmit a localization signal. Each localization signal can be directed at any of the reconfigurable reflective surfaces to localize the position of the UAV in the environment.

For localization, the reconfigurable reflective surfaces can be in a second configuration. An example of the second configuration is shown in FIG. 3. For example, the management computer can send to a controller for each reconfigurable reflective surface, a fourth instruction message to configure each reconfigurable reflective surface into a second configuration. The second configuration can direct a single instance of the localization signal. The second configuration can be configured based on a coded beam index indicating a position of elements of each reconfigurable reflective surface for each time slot.

At 1008, localizing the UAV can also include detecting a reception of any of the localization signals at any of the base station and/or the reference node(s). For example, in the example in FIG. 5, a localization signal 510A transmitted by BS 504 can be redirected by RIS, with reflected signal 510B being directed at UAV 502. The signal 510B can be deflected off UAV 502, and the deflected signal 510C can be received at the reference node 506.

At 1010, localizing the UAV can also include determining the position of the UAV in the environment using data relating to any of the localization signals received at any of the base station and/or the reference node (e.g., AoA and/or AoD information). The management computer can identify multiple angles at which the localization signal was transmitted by the base station, reflected by the RIS, and/or angles at which deflected localization signals were received at any of a reference node, the RIS, and the base station. For example, three different angles from one or more RIS instances or reference nodes can be used to derive AoA and/or AoD information to localize the UAV.

For instance, deriving the position of the UAV in the environment can further include, for each received localization signal, derive an angle of departure (AoD) specifying an angle of elements in the corresponding reconfigurable reflective surface in the second configuration at a time of transmitting the localization signal from the corresponding base station. Each derived angle of departure can be processed with known locations of each of the base station and/or the reference node to derive the position of the UAV in the environment.

As another example, deriving the position of the UAV in the environment can further include, for each received localization signal, deriving an angle of arrival specifying an angle at which the received localization signal was received at any of the at least two base stations and/or the reference nodes. Each derived angle of arrival can be processed with known locations of each of the base station and/or the reference node to derive the position of the UAV in the environment.

At 1016, the method can include generating a notification message specifying the derived position of the UAV in the environment. The notification message can be provided to a user device and can provide coordinates of the UAV in the environment.

In some instances, responsive to deriving the position of the UAV in the environment, the management computer can establish a wireless connection between the UAV and any of the base station for subsequent data transmission between the UAV and the base station.

In some embodiments, the RIS can comprise a hybrid RIS design. A hybrid RIS design can include an RIS capable of both reflecting signals as well as providing details relating to a deflected signal received at the RIS. For example, if a localization signal is deflected off a UAV and received at the RIS, an angle of departure of the localization signal and/or an angle of arrival of the deflected signal can be determined.

In some instances, any of the reconfigurable reflective surfaces are configured to either reflect detection signals and/or localization signals and refract other signals to other user devices. Further, any of the reconfigurable reflective surfaces can be configured to both deflect detection and/or localization signals, and also receive the localization signal deflected from the UAV. Determining the position of the UAV in the environment can include deriving an angle of arrival of the received localization signal deflected from the UAV at the reconfigurable reflective surface that includes a signal reception and sensing capability (e.g., an RIS as described in FIG. 8).

In another example embodiment, a system can include at least one base station, at least one reconfigurable reflective surface, and a management computer in electrical communication with the at least one base station and the at least one reconfigurable reflective surface. The management computer can be operative to send a first instruction message to the at least one base station to transmit a detection signal. The detection signal can be directed the at least one base station to the at least one configurable reflective surface to re-direct the detection signal. The management computer can also be operative to detect a reception of the detection signal. The received detection signal can indicate a detection of an unmanned aerial vehicle (UAV) in an environment.

The management computer can also be operative to send a second instruction message to the at least one base station to transmit a localization signal. The localization signal can be directed to the at least one reconfigurable reflective surface to localize a position of the UAV in the environment. The management computer can also be operative to detect a reception of the localization signal. The management computer can also be operative to derive the position of the UAV in the environment based on a series of parameters relating to the received localization signal. The management computer can also be operative to generate a notification message specifying the derived position of the UAV in the environment.

In some instances, the management computer is further operative to send a third instruction message to a controller for the reconfigurable reflective surface to configure the reconfigurable reflective surface into a first configuration. The first configuration can split the detection signal into multiple simultaneous beams in a sub-array pattern.

In some instances, the management computer is further operative to send a fourth instruction message to a controller for each reconfigurable reflective surface to configure the reconfigurable reflective surface into a second configuration. The second configuration can direct a single instance of the localization signal.

In some instances, the fourth instruction message provides a coded beam index indicating a position of elements of the reconfigurable reflective surface for each time slot.

In some instances, the position of the UAV in the environment is derived using a combination of any of an angle of departure of the localization signal, an angle of arrival, and a position of the at least one base station.

In some instances, deriving the position of the UAV in the environment further includes, for the received localization signal, derive an angle of departure specifying an angle of elements in the reconfigurable reflective surface in the second configuration at a time of transmitting the localization signal from the base station, and processing the derived angle of departure with a known location of the at least one base station to derive the position of the UAV in the environment.

In some instances, deriving the position of the UAV in the environment further includes, for the received localization signal, deriving an angle of arrival specifying an angle at which the received localization signal was received at the at least one base station, and processing the derived angle of arrival with a known location of the at least one base station to derive the position of the UAV in the environment.

In some instances, the management computer is further operative to detect the reception of the localization signal at a reference node. The position of the UAV in the environment is derived based at least on an angle of arrival of the localization signal at the reference node and a position of the reference node in the environment.

In some instances, the reconfigurable reflective surface is connected to the at least one base station or positioned a distance away from the at least one base station.

In another example embodiment, a computer-readable storage medium is provided. The computer-readable storage medium contains program instructions for a method being executed by an application, the application comprising code for one or more components that are called by the application during runtime. Execution of the program instructions by one or more processors of a computer system can cause the one or more processors to perform steps comprising: sending a first instruction message to each base stations to transmit a detection signal. Each detection signal can be directed by each base station to corresponding reconfigurable reflective surfaces.

Execution of the program instructions can further cause the one or more processors to perform steps comprising detecting a reception of any of the detection signals received at any of the base stations and/or a reference node. Any of the received detection signals indicate a detection of an unmanned aerial vehicle (UAV) in an environment.

Execution of the program instructions can further cause the one or more processors to perform steps comprising sending, to each of the base stations, a second instruction message for each of the base stations to transmit a localization signal. Each localization signal can be directed at any of at least one reconfigurable reflective surfaces to localize a position of the UAV in the environment. Execution of the program instructions can further cause the one or more processors to perform steps comprising detecting a reception of any of the localization signals at any of the base stations and/or the reference node.

Execution of the program instructions can further cause the one or more processors to perform steps comprising deriving the position of the UAV in the environment using a combination of an angle of departure of the localization signal transmitted from the corresponding base station and reflected by the corresponding reconfigurable reflective surface, an angle of arrival at the corresponding base station and reflected by the corresponding reconfigurable reflective surface, and a position of any of the base stations and the reference node. Execution of the program instructions can further cause the one or more processors to perform steps comprising generating a notification message specifying the derived position of the UAV in the environment.

### Computing System Overview

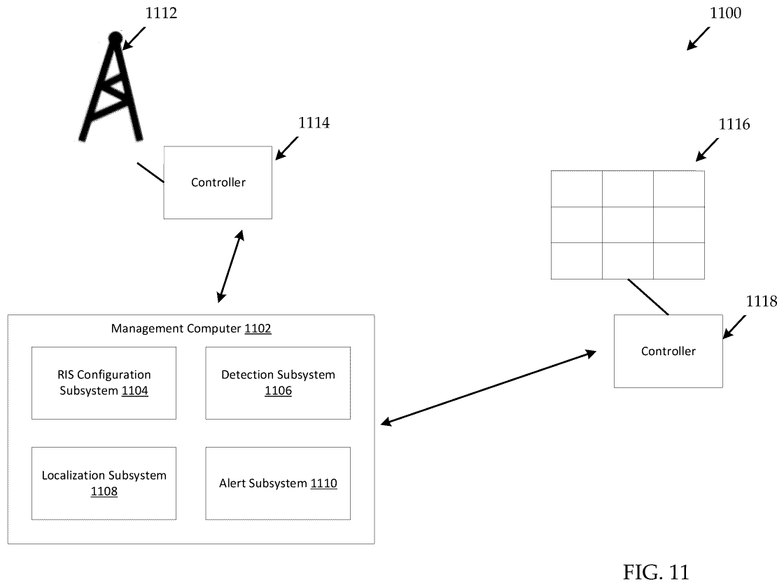

As described above, a management computer (or otherwise referred to as a “fusion center”) can interact with base stations and RIS instances to detect and localize a UAV as described herein. FIG. 11 illustrates an example system 1100 for detecting and localizing a UAV in an environment.

As shown in FIG. 11, a management computer 1102 can interact with controllers 1114, 1118 for base stations (e.g., 1112) and RIS instances (e.g., 1116), respectively. The management computer 1102 as described herein can be implemented on one or more computing nodes disposed at any base station, RIS instance, or include a series of interconnected computing devices in electronic communication with the controllers (e.g., as part of a cloud computing network).

The controllers 1114, 1118 can execute instructions provided by the management computer 1102. For example, controller 1114 can cause the base station 1112 to transmit a detection signal or localization signal as described herein responsive to an instruction provided by the management computer 1102. As another example, the controller 1118 can cause the RIS 1116 to be configured in a first configuration or a second configuration as described herein responsive to an instruction provided by the management computer 1102.

Further, as shown in FIG. 11, the management computer 1102 can include multiple subsystems. For example, the management computer 1102 can include any of an RIS configuration subsystem 1104, a detection subsystem 1106, a localization subsystem 1108, and an alert subsystem 1110.

The RIS configuration subsystem 1104 can manage configurations of the RIS (e.g., 1116) during the detection and localization processes as described herein. As noted above, the RIS can be reconfigurable between multiple configurations. For example, for UAV detection, the RIS can be configured in a first configuration (e.g., the RIS configuration in FIG. 2) to split a detection signal into multiple simultaneous beams, or the RIS can be configured in a second configuration (e.g., the configuration in FIG. 3) for localizing a UAV in the environment. Further, in some instances, the RIS configuration subsystem 1104 can manage timing to assign timeslots to detection and localization signal transmission by base stations and to instruct the RIS to transition into a corresponding configuration at the timeslots.

The detection subsystem 1106 can initiate and manage detection of one or more UAVs in an environment. For example, the detection subsystem 1106 can send instructions to controllers (e.g., 1114) for base stations (e.g., 1112) to transmit detection signals at specified time slots. For instance, as shown in FIG. 1, the fusion center 114 can send an instruction to transmit a detection signal (e.g., 108A) to the RIS 106 in a first configuration (as managed by the RIS configuration subsystem 1104).

The detection subsystem 1106 can further identify deflected detection signals and determine that a UAV is present in the environment. For example, the detection signal 108B can be deflected off of a UAV 102A and received at a reference node 112. The detection subsystem 1106 can identify that the reference node 112 received the deflected signal, and the received signal can be processed to determine the signal was deflected off of a UAV 102A.

The localization subsystem 1108 can perform localization of a detected UAV in an environment. For example, the localization subsystem 1108 can send instructions to controllers (e.g., 1114) for base stations (e.g., 1112) to transmit localization signals at specified time slots. The localization signals can be reflected off of RIS instances in a second configuration that is configured to direct a single signal at a specific angle for each time slot to localize the signal. The localization signal can reflect off of the UAV and then be received at a base station, RIS instance, and/or a reference node.

The localization subsystem 1108 can use the received localization signal and identify multiple angles of departure and angles of arrival for the received localization signal. For example, angles of departure (AoD) can include an angle of the localization signal being sent from the base station or deflected by the RIS instance. An angle of arrival (AoA) can include an angle of the localization signal received at a reference node, the RIS, and/or the base station.

Further, the localization subsystem 1108 can utilize a localization algorithm using the AoD and/or AoA information of a received localization signal to determine a position of the UAV in the environment. For example, the localization algorithm can utilize AoD information specifying departing angles of separate localization signal instances directed off of corresponding RIS instances to triangulate a position of the UAV in the environment.

As another example, the localization algorithm can utilize AoA information specifying arriving angles of separate localization signal instances from the UAV and received at reference nodes, RIS instances, and/or base stations to triangulate a position of the UAV in the environment. The localization algorithm can also utilize a time of transmission of the localization signal(s), a time of arrival of the deflected localization signals, and a position of each base station, RIS instance, and reference node in the environment. The localization algorithm can output a position of the UAV in the environment as a set of coordinates or other suitable set of data.

The alert subsystem 1110 can generate alert notifications specifying the localized UAV. For example, the alert subsystem 1110 can provide coordinates of a UAV to an operator device for further analysis (e.g., determining an action to take with the located UAV). After localization of the UAV, any of a variety of actions can be taken. For example, a wireless connection can be established between the cellular network and the UAV to establish control of the UAV or otherwise communicate with an operator of the UAV. In some instances, the UAV can be provided an alert message indicating that the UAV is included in a restricted area in the environment.

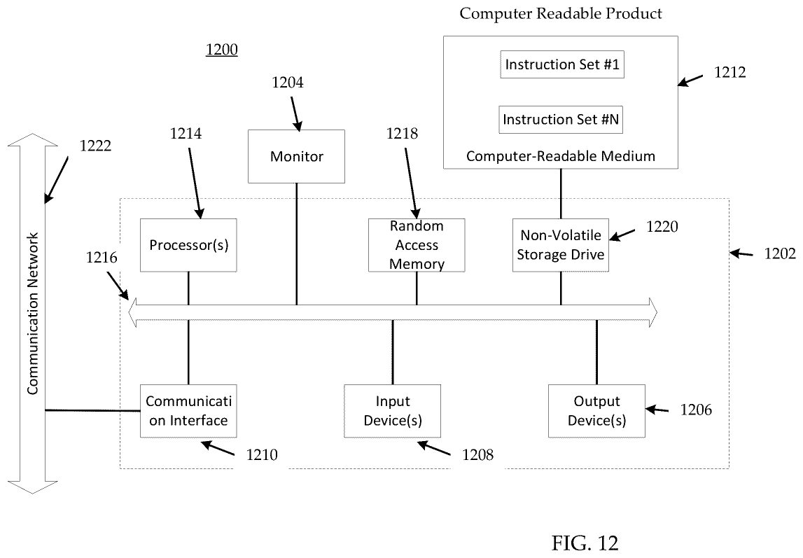

FIG. 12 is a block diagram of a special-purpose computer system 1200 according to an embodiment. For example, system 1200 can deployed as part of management computer 114 in FIG. 1. The methods and processes described herein may similarly be implemented by tangible, non-transitory computer readable storage mediums and/or computer-program products that direct a computer system to perform the actions of the methods and processes described herein. Each such computer-program product may comprise sets of instructions (e.g., codes) embodied on a computer-readable medium that directs the processor of a computer system to perform corresponding operations. The instructions may be configured to run in sequential order, or in parallel (such as under different processing threads), or in a combination thereof.

Special-purpose computer system 1200 comprises a computer 1202, a monitor 1204 coupled to computer 1202, one or more additional user output devices 1206 (optional) coupled to computer 1202, one or more user input devices 1208 (e.g., keyboard, mouse, track ball, touch screen) coupled to computer 1202, an optional communications interface 1210 coupled to computer 1202, and a computer-program product including a tangible computer-readable storage medium 1212 in or accessible to computer 1202. Instructions stored on computer-readable storage medium 1212 may direct system 1200 to perform the methods and processes described herein. Computer 1202 may include one or more processors 1214 that communicate with a number of peripheral devices via a bus subsystem 1216. These peripheral devices may include user output device(s) 1206, user input device(s) 1208, communications interface 1210, and a storage subsystem, such as random access memory (RAM) 1218 and non-volatile storage drive 1220 (e.g., disk drive, optical drive, solid state drive), which are forms of tangible computer-readable memory.

Computer-readable medium 1212 may be loaded into random access memory 1218, stored in non-volatile storage drive 1220, or otherwise accessible to one or more components of computer 1202. Each processor 1214 may comprise a microprocessor, such as a microprocessor from Intel® or Advanced Micro Devices, Inc.®, or the like. To support computer-readable medium 1212, the computer 1202 runs an operating system that handles the communications between computer-readable medium 1212 and the above-noted components, as well as the communications between the above-noted components in support of the computer-readable medium 1212. Exemplary operating systems include Windows® or the like from Microsoft Corporation, Solaris® from Sun Microsystems, LINUX, UNIX, and the like. In many embodiments and as described herein, the computer-program product may be an apparatus (e.g., a hard drive including case, read/write head, etc., a computer disc including case, a memory card including connector, case, etc.) that includes a computer-readable medium (e.g., a disk, a memory chip, etc.). In other embodiments, a computer-program product may comprise the instruction sets, or code modules, themselves, and be embodied on a computer-readable medium.

User input devices 1208 include all possible types of devices and mechanisms to input information to computer system 1202. These may include a keyboard, a keypad, a mouse, a scanner, a digital drawing pad, a touch screen incorporated into the display, audio input devices such as voice recognition systems, microphones, and other types of input devices. In various embodiments, user input devices 1208 are typically embodied as a computer mouse, a trackball, a track pad, a joystick, wireless remote, a drawing tablet, a voice command system. User input devices 1208 typically allow a user to select objects, icons, text and the like that appear on the monitor 1204 via a command such as a click of a button or the like. User output devices 1206 include all possible types of devices and mechanisms to output information from computer 1202. These may include a display (e.g., monitor 1204), printers, non-visual displays such as audio output devices, etc.

Communications interface 1210 provides an interface to other communication networks and devices and may serve as an interface to receive data from and transmit data to other systems, WANs and/or the Internet, via a wired or wireless communication network 1222. In addition, communications interface 1210 can include an underwater radio for transmitting and receiving data in an underwater network. Embodiments of communications interface 1210 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 1210 may be coupled to a computer network, to a FireWire® bus, or the like. In other embodiments, communications interface 1210 may be physically integrated on the motherboard of computer 1202, and/or may be a software program, or the like.

RAM 1218 and non-volatile storage drive 1220 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 1218 and non-volatile storage drive 1220 may be configured to store the basic programming and data constructs that provide the functionality of various embodiments of the present invention, as described above.

Software instruction sets that provide the functionality of the present invention may be stored in computer-readable medium 1212, RAM 1218, and/or non-volatile storage drive 1220. These instruction sets or code may be executed by the processor(s) 1214. Computer-readable medium 1212, RAM 1218, and/or non-volatile storage drive 1220 may also provide a repository to store data and data structures used in accordance with the present invention. RAM 1218 and non-volatile storage drive 1220 may include a number of memories including a main random access memory (RAM) to store instructions and data during program execution and a read-only memory (ROM) in which fixed instructions are stored. RAM 1218 and non-volatile storage drive 1220 may include a file storage subsystem providing persistent (non-volatile) storage of program and/or data files. RAM 1218 and non-volatile storage drive 1220 may also include removable storage systems, such as removable flash memory.

Bus subsystem 1216 provides a mechanism to allow the various components and subsystems of computer 1202 communicate with each other as intended. Although bus subsystem 1216 is shown schematically as a single bus, alternative embodiments of the bus subsystem may utilize multiple busses or communication paths within the computer 1202.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

### CONCLUSION

Whereas many alterations and modifications of the present invention will no doubt become apparent to a person of ordinary skill in the art after having read the foregoing description, it is to be understood that the particular embodiments shown and described by way of illustration are in no way intended to be considered limiting.

Moreover, the processes described above, as well as any other aspects of the disclosure, may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and optical data storage devices. In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one electronic device to another electronic device using any suitable communications protocol. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any or each module of any one or more of any system, device, or server may be provided as a software construct, firmware construct, one or more hardware components, or a combination thereof, and may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules of any one or more of any system device, or server are merely illustrative, and that the number, configuration, functionality, and interconnection of existing modules may be modified or omitted, additional modules may be added, and the interconnection of certain modules may be altered.

While there have been described systems, methods, and computer-readable media for enabling efficient control of a media application at a media electronic device by a user electronic device, it is to be understood that many changes may be made therein without departing from the spirit and scope of the disclosure. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A method performed by a management computer to detect and localize a position of an unmanned aerial vehicle (UAV) in an environment, the method comprising:
detecting a presence of the UAV in the environment by:
sending a first instruction message to at least one base station to transmit a detection signal, wherein each detection signal is re-directed by the at least one base station to a corresponding reconfigurable reflective surface; and
detecting a reception of any of the detection signals received at one or more base stations and/or a reference node, wherein any of the received detection signals indicates a detection of the UAV in the environment;
deriving a position of the UAV in the environment by:
sending, to the at least one base station, a second instruction message to transmit a localization signal, wherein each localization signal is directed at any of the reconfigurable reflective surfaces to localize the position of the UAV in the environment;
detecting a reception of any of the localization signals at any of the at least one base station and/or the reference node; and
determining the position of the UAV in the environment using data relating to any of the localization signals received at any of the at least one base station and/or the reference node; and
generating a notification message specifying the derived position of the UAV in the environment.

2. The method of claim 1, further comprising:
sending, to a controller for each reconfigurable reflective surface, a third instruction message to configure each reconfigurable reflective surface into a first configuration, the first configuration splitting the detection signal into multiple simultaneous beams in a sub-array pattern.

3. The method of claim 1, further comprising:
sending, to a controller for each reconfigurable reflective surface, a fourth instruction message to configure each reconfigurable reflective surface into a second configuration, the second configuration directing a single instance of the localization signal.

4. The method of claim 3, wherein the fourth instruction message provides a coded beam index indicating a position of elements of each reconfigurable reflective surface for each time slot.

5. The method of claim 1, wherein any of the reconfigurable reflective surfaces are configured to either reflect detection signals and/or localization signals and refract other signals to other user devices.

6. The method of claim 1, wherein deriving the position of the UAV in the environment further includes:
for each received localization signal, derive an angle of departure specifying an angle at which the corresponding reconfigurable reflective surface in the second configuration directed each corresponding localization signal at a time of transmitting the localization signal from the corresponding base station; and
processing each derived angle of departure with known locations of each of the at least one base station and/or the reference node to derive the position of the UAV in the environment.

7. The method of claim 1, wherein deriving the position of the UAV in the environment further includes:
for each received localization signal, deriving an angle of arrival specifying an angle at which the received localization signal was received at the at least one base station and/or the reference node; and
processing each derived angle of arrival with known locations of each of the at least one base station and/or the reference node to derive the position of the UAV in the environment.

8. The method of claim 1, further comprising
responsive to deriving the position of the UAV in the environment, establishing a wireless connection between the UAV and any of the at least one base station for subsequent data transmission between the UAV and the base station.

9. The method of claim 1, wherein any of the reconfigurable reflective surfaces are configured to both deflect detection and/or localization signals, and also receive the localization signal deflected from the UAV, wherein determining the position of the UAV in the environment includes deriving an angle of arrival of the received localization signal deflected from the UAV at the reconfigurable reflective surface.

10. A system comprising:
one or more base stations;
one or more reconfigurable reflective surfaces; and
a management computer in electrical communication with the one or more base stations and the at least one reconfigurable reflective surface, where the management computer is operative to:
send a first instruction message to the one or more base stations to transmit a detection signal, wherein each detection signal is directed the one or more base stations to corresponding configurable reflective surface to re-direct each detection signal;
detect a reception of the detection signal, wherein the received detection signal indicates a detection of an unmanned aerial vehicle (UAV) in an environment;
send a second instruction message to each the one or more base stations to transmit a localization signal, wherein each localization signal is directed to corresponding reconfigurable reflective surfaces to localize a position of the UAV in the environment;
detect a reception of the localization signal;
derive the position of the UAV in the environment based on a series of parameters relating to the received localization signal; and
generate a notification message specifying the derived position of the UAV in the environment.

11. The system of claim 10, wherein the management computer is further operative to:
send a third instruction message to a controller for the reconfigurable reflective surface to configure the reconfigurable reflective surface into a first configuration, the first configuration splitting the detection signal into multiple simultaneous beams in a sub-array pattern.

12. The system of claim 10, wherein the management computer is further operative to:
send a fourth instruction message to a controller for each reconfigurable reflective surface to configure the reconfigurable reflective surface into a second configuration, the second configuration directing a single instance of the localization signal.

13. The system of claim 12, wherein the fourth instruction message provides a coded beam index indicating a position of elements of the reconfigurable reflective surface for each time slot.

14. The system of claim 10, wherein the position of the UAV in the environment is derived using a combination of any of: an angle of departure of the localization signal, an angle of arrival, and a position of the one or more base stations, a reference node, and/or each reconfigurable reflective surface.

15. The system of claim 14, wherein deriving the position of the UAV in the environment further includes:
for the received localization signal, derive an angle of departure specifying an angle of elements in the reconfigurable reflective surface in the second configuration at a time of transmitting the localization signal from the one or more base stations; and
processing the derived angle of departure with a known location of the one or more base stations to derive the position of the UAV in the environment.

16. The system of claim 14, wherein deriving the position of the UAV in the environment further includes:
for the received localization signal, deriving an angle of arrival specifying an angle at which the received localization signal was received at the at one or more base stations; and
processing the derived angle of arrival with a known location of one or more base stations to derive the position of the UAV in the environment.

17. The system of claim 10, wherein the management computer is further operative to:
detect the reception of the localization signal at a reference node, wherein the position of the UAV in the environment is derived based at least on an angle of arrival of the localization signal at the reference node and a position of the reference node in the environment.

18. The system of claim 10, wherein the reconfigurable reflective surface is connected to the one or more base stations or positioned a distance away from the at one or more base stations.

19. A computer-readable storage medium containing program instructions for a method being executed by an application, the application comprising code for one or more components that are called by the application during runtime, wherein execution of the program instructions by one or more processors of a computer system causes the one or more processors to perform steps comprising:
sending a first instruction message to each of at least two base stations to transmit a detection signal, wherein each detection signal is directed by each of the at least two base stations to corresponding reconfigurable reflective surfaces;
detecting a reception of any of the detection signals received at any of the at least two base stations and/or a reference node, wherein any of the received detection signals indicate a detection of an unmanned aerial vehicle (UAV) in an environment;
sending, to each of the at least two base stations, a second instruction message for each of the at least two base stations to transmit a localization signal, wherein each localization signal is directed at any of at least one reconfigurable reflective surfaces to localize a position of the UAV in the environment;
detecting a reception of any of the localization signals at any of the at least two base stations and/or the reference node;
deriving the position of the UAV in the environment using a combination of an angle of departure of the localization signal transmitted from the corresponding base station and reflected by the corresponding reconfigurable reflective surface, an angle of arrival at the corresponding base station and reflected by the corresponding reconfigurable reflective surface, and a position of any of the at least two base stations and the reference node; and
generating a notification message specifying the derived position of the UAV in the environment.

20. The computer-readable storage medium of claim 19, wherein execution of the program instructions further causes the one or more processors to perform steps comprising:
sending, to a controller for each reconfigurable reflective surface, a third instruction message to configure each reconfigurable reflective surface into a first configuration, the first configuration splitting the detection signal into multiple simultaneous beams in a sub-array pattern.
